(19) United States
(12) Patent Application Publication
(10) Pub. No.: US 2009/0009653 A1
(43) Pub. Date: Jan. 8, 2009

(54) AUTO FOCUS SYSTEM AND AUTO FOCUS METHOD FOR USE IN VIDEO CAMERAS

(75) Inventor: SHEN-FU TSAI, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/946,295

(22) Filed: Nov. 28, 2007

(30) Foreign Application Priority Data
Jul. 6, 2007 (CN) 200710201019.2

(51) Int. Cl. H04N 5/232

(52) U.S. Cl. 348/353; 348/E05.045

(57) ABSTRACT

An exemplary auto focus method for use in video cameras including a focus lens includes: focusing the pickup lens and capturing a current image and a prior image; calculating two contrast estimation values of the current image and the prior image; and judging whether a difference between the contrast estimation value of the current image and that of the prior image exceeds a predetermined threshold, if yes, refocusing the pickup lens, if no, keeping focus status of the pickup lens unchanged and capturing a subsequent image.

### BACKGROUND

1. Technical Field

The invention relates to image technology and, particularly, relates to an auto focus system and an auto focus method for use in video cameras.

2. Description of Related Art

Most video cameras continuously adjust a focus lens thereof to maintain focus on a changing object scene. However, in some cases, changes in the object scene may be so minor (such as those caused by, e.g., handshaking or mere brightness changing of background) as to not require lens adjustment to achieve a sharp image. Therefore the continuous power-consuming adjustments are wasteful.

Therefore, it is desirable to provide an auto focus system and an auto focus method for use in video cameras, which can overcome the above-mentioned problems.

### SUMMARY

In a present embodiment, an auto focus method for use in video cameras including a focus lens includes: focusing the pickup lens and capturing a current image and a prior image; calculating two contrast estimation values of the current image and the prior image; and judging whether a difference between the contrast estimation value of the current image and that of the prior image exceeds a predetermined threshold, if yes, refocusing the pickup lens, if no, keeping focus status of the pickup lens unchanged and capturing a subsequent image.

### BRIEF DESCRIPTION OF THE DRAWINGS

Many aspects of the present embodiments should be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a functional block diagram of an auto focus system including a calculating unit, according to a first embodiment.

FIG. 2 is a schematic view showing an algorithm of the calculating unit of FIG. 1.

FIG. 3 is a flow chart of an auto focus method, according to the first embodiment.

FIG. 4 is a schematic view showing a principle of a portion of the auto focus method of FIG. 3.

FIG. 5 is a schematic view of an auto focus system of a second embodiment, which is essentially similar to auto focus system of FIG. 1 but further including a dividing unit and a weighting unit.

FIG. 6 is a schematic view showing an algorithm of a set of the dividing unit, the calculating unit, and the weighting unit of FIG. 5.

### DETAILED DESCRIPTION OF THE EMBODIMENTS

Embodiments of the present system and method will now be described in detail with references to the drawings.

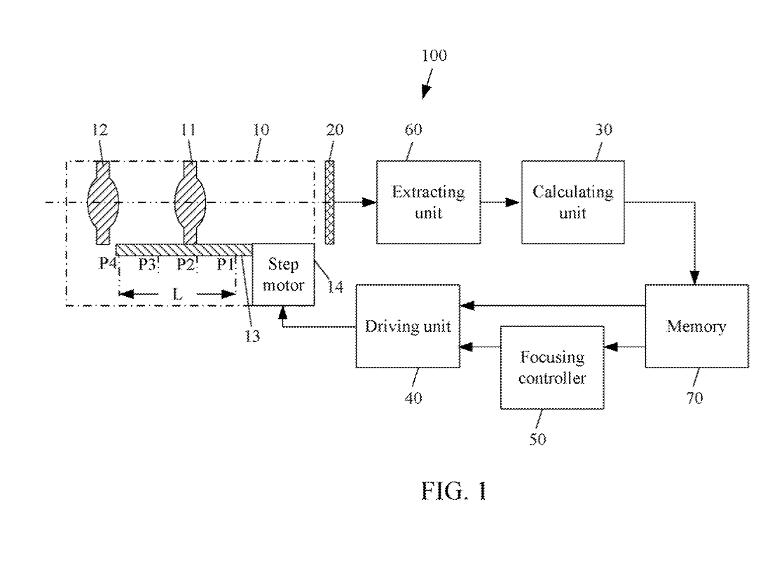

Referring to FIG. 1, an auto focus system 100 for use in video cameras, according to a first embodiment, includes a pickup lens 10, an image sensor 20, a calculating unit 30, a driving unit 40, and a focusing controller 50. The pickup lens includes a focus lens 11. The pickup lens 10 and the image sensor 20 are arranged so that incident light from an object scene (not shown) is focused by the focus lens 11 onto the image sensor 20 and is converted by the image sensor 20 into a number of consecutive images. The consecutive images includes a current image and a prior image. The calculating unit 30 is configured for calculating a contrast estimation value of each of the images. The driving unit 40 is configured for moving the focus lens 11 to focus incident light from the object scene onto the image sensor 20. The focusing controller 50 is configured for judging whether a difference between the contrast estimation value of the current image and that of the prior image exceeds a predetermined threshold, if yes, activating the driving unit 40, if no, deactivating the driving unit 40.

Specifically, in addition to the focus lens 11, the pickup lens 10 further includes a zoom lens 12, a lead screw 13, and a step motor 14. The focus lens 11 and the zoom lens 12 are coaxially arranged. The focus lens 11 is engaged with the lead screw 13 so that the focus lens 11 can be forced to move by the step motor 14 driving the lead screw 13 to rotate, and be guided by the lead screw 13 that is configured for power transmission to move stepwise along the optical axis thereof, and is restricted to move within a focus range L that is defined, for example, by four focus positions P1˜P4 therein by the cooperation of the step motor 14 and the lead screw 13. The zoom lens 12 is slidable along the optical axis thereof to change the focal length of the pickup lens 10. It is to be noted that the pickup lens 10 is not limited in this embodiment, but could alternatively comprise other lenses with focus function.

The imaging sensor 20 can be a charge coupled device (CCD) image sensor or a complementary metal oxide semiconductor (CMOS) image sensor. It is known that the image generated by the image sensor 20 is composed of three color components (i.e., red (R), green (G) and blue (B)), but the contrast estimation value can be calculated only using the brightness component of the image. Therefore, in order to simplify function of the calculating unit 30, an extracting unit 60 is employed to extract the brightness component from the image for the calculating unit 30.

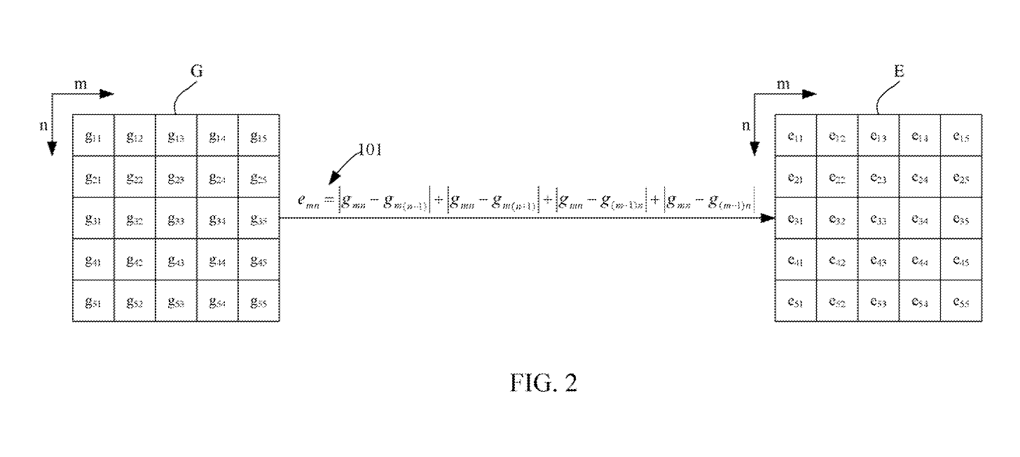

Referring to FIG. 2, an exemplary algorithm of the calculating unit 30 is shown, where G is the extracted brightness component of the image, gₘₙ is the grayscale value (brightness value) of a pixel of the image at the intersection of line m and row n (m, n are positive integers). The calculating unit 30 calculates a contrast value array E of the image according a first equation 101 (eₘₙ is an element of the contrast value array E at the intersection of line m and row n), and the contrast value array E is a function of the contrast estimation value, for example, the contrast estimation value is the sum of all elements eₘₙ of the contrast value array E. It should be understood that though only twenty-five (5×5) pixels are shown in FIG. 2, the number of pixels of an actual image is much greater than twenty-five.

Understandably, the contrast estimation value indicates the sharpness level of the image, and will approach its maximum when the incident light from the object scene is focused onto the image sensor 20. Therefore, the driving unit 40 can move the focus lens 11 to focus the pickup lens 10 by comparing four contrast estimation values of four images corresponding to the four focus positions P1˜P4 to find out the focus position where the respective image has the highest contrast estimation value (referred as “focused position”), and controlling the step motor 14 to force the focus lens 11 to move to the focused position. It also should be understood that the contrast estimation value might change throughout the period of shooting should the object scene change. But, if the change of the object scene (such as may be caused by, e.g., handshaking or mere brightness changing of background) is minor, then the difference between two contrast estimation values of two consecutive images (i.e., the current and prior image) is minor too. Therefore, the focusing controller 50 can determine whether activation of the driving unit 40 is needed or not by judging whether the difference between the contrast estimation value of a current image and that of a prior image is minor enough (smaller than the predetermined threshold) or not.

Specifically, the calculated contrast estimation values are stored in a memory 70, thus, the driving unit 40 can obtain the contrast estimation values to be compared from the memory 70, and the focusing controller 50 can obtain the contrast estimation valued for judgement from the memory 70 too.

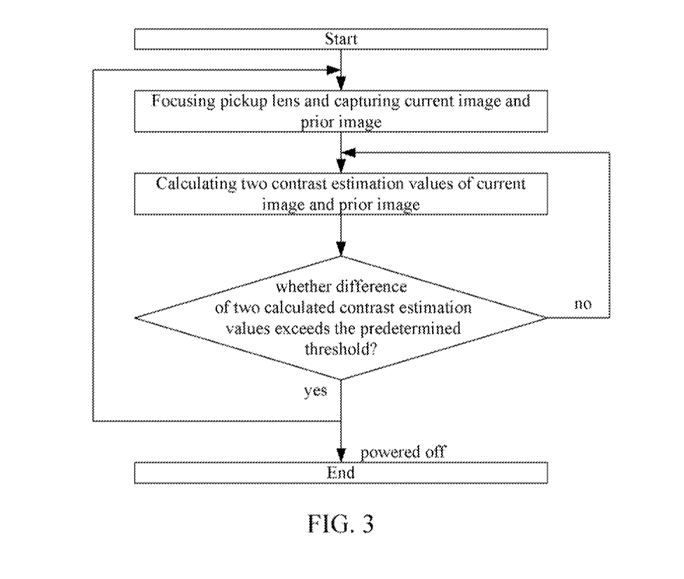

Referring to FIG. 3, an auto focus method of the first embodiment includes the operations of:

Operation 110: focusing the pickup lens 10 and capturing a current image and a prior image; in detail, when the video camera is started or activated by the focusing controller 50; the driving unit 40 drives the step motor 14 to force the focus lens 11 to move to each of the focus positions P1 to P2, P3, P4, to obtain four consecutive images; then, the calculating unit 30 calculates four contrast estimation values of the four images corresponding to the four focus positions P1˜P4, and stores them in the memory 70; next, the driving unit 40 compares the four contrast estimation values to find out the highest contrast estimation value; finally, the driving unit 40 controls the step motor 14 to force the focus lens 11 to move to the focus position where the respective image has the highest contrast estimation value (i.e., the focused position); thus, the focus lens 11 is focused and will be kept at that focused position, and the driving unit 40 starts idling until it is activated by the focusing controller 50 again to drive the focus lens 11 to a new focused position; in addition, the image sensor 20 continuously captures the current image and the prior image with the pickup lens 10 in focus status.

Operation 120: calculating two contrast estimation values of the current image and the prior image; specifically, the calculating unit 30 implements this operation; and

Operation 130: judging whether a difference of the two calculated contrast estimation values exceeds the predetermined threshold, if yes, refocusing the pickup lens 10, if no, keeping focus status of the pickup lens 10 unchanged and capturing a subsequent image.

Understandably, the abovementioned operation 110˜130 is just a cycle of the actual operation of the auto focus system 100. In practice, the operations cycles until the video cameras is powered off. In order to provide a better understanding of the operations 110˜130, a more detailed description is given below.

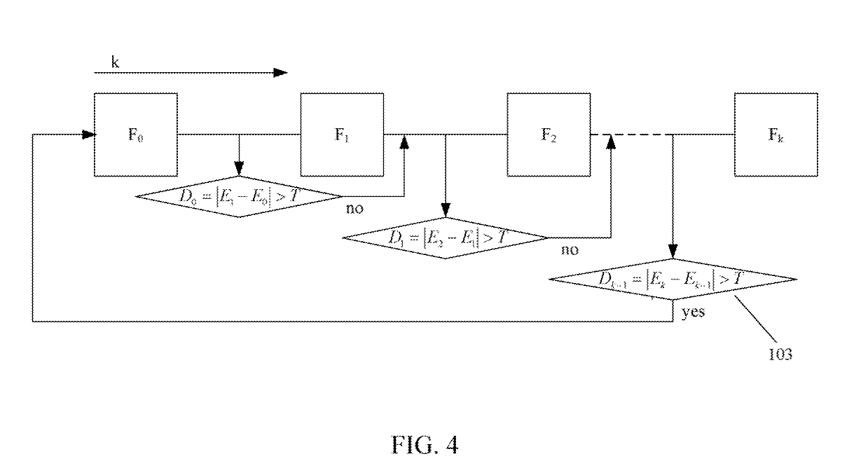

As illustrated in FIG. 4, F₀˜Fₖ (k is positive integer) is the consecutive images generated by the image sensor 20 with the pickup lens 10 in focus status (F₀ is the image captured when the focus lens 11 arrives the focused position). The operations 120, 130 are realized by the sub-operations of: the calculating unit 30 calculates the contrast value arrays E₀, E₁, and stores them in the memory 70; the focusing controller 50 reads the two contrast value arrays E₀, E₁ from the memory 70, and judges whether the difference Do between the contrast value arrays E₀, E₁ exceeds the predetermined threshold T using the third equation 103; if the difference D₀ exceeds the predetermined threshold, the object scene has changed enough to warrant refocusing, so, the focusing controller 50 activates the driving unit 40 to refocus the pickup lens 10; if the difference D₀ does not exceed the predetermined threshold, there are minor changes, if any, in the object scene that warrant refocusing, so, the focusing controller 50 leaves the driving unit 40 idling, and the image sensor 20 captures a subsequent image; the calculating unit 30 lets the subsequent image as a new current image, and the current image as a new prior image, and calculates the contrast estimation value of them for the next operation 130 (judging operation); the auto focus system 100 cycles through the operations 120, 130 until the difference Dₖ₋₁ between the two contrast value arrays Eₖ₋₁, Eₖ exceeds the predetermined threshold or the video camera is powered off.

In this embodiment, the contrast estimation value is the sum of all elements of the respective contrast value array. The predetermined threshold is settable, and is determined depending on the quality requirement of the sequence of images.

Clearly, with the cooperation of the driving unit 40 and the focusing controller 50, the auto focus system 100 implementing the auto focus method will consume less power.

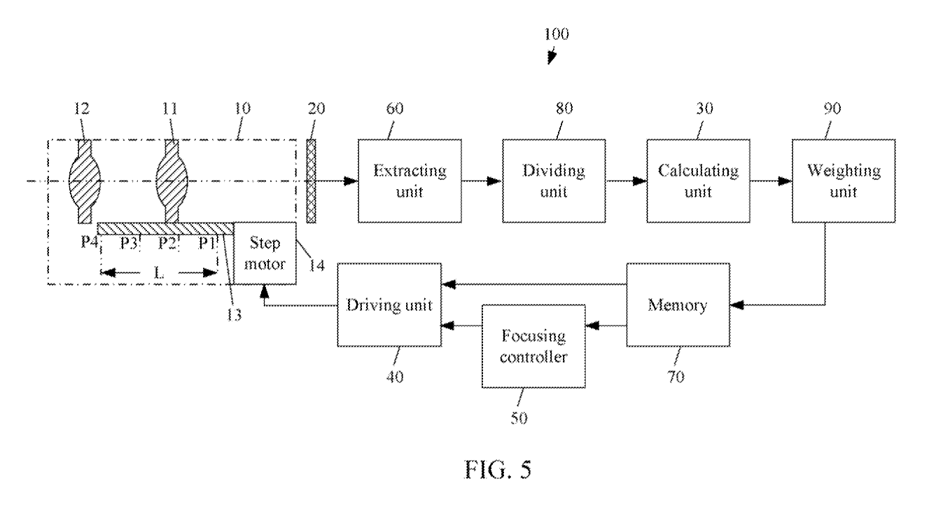

Referring to FIG. 5, another auto focus system 200 of a second embodiment is essentially similar to the auto focus system 100 but further including a dividing unit 80, and a weighting unit 90.

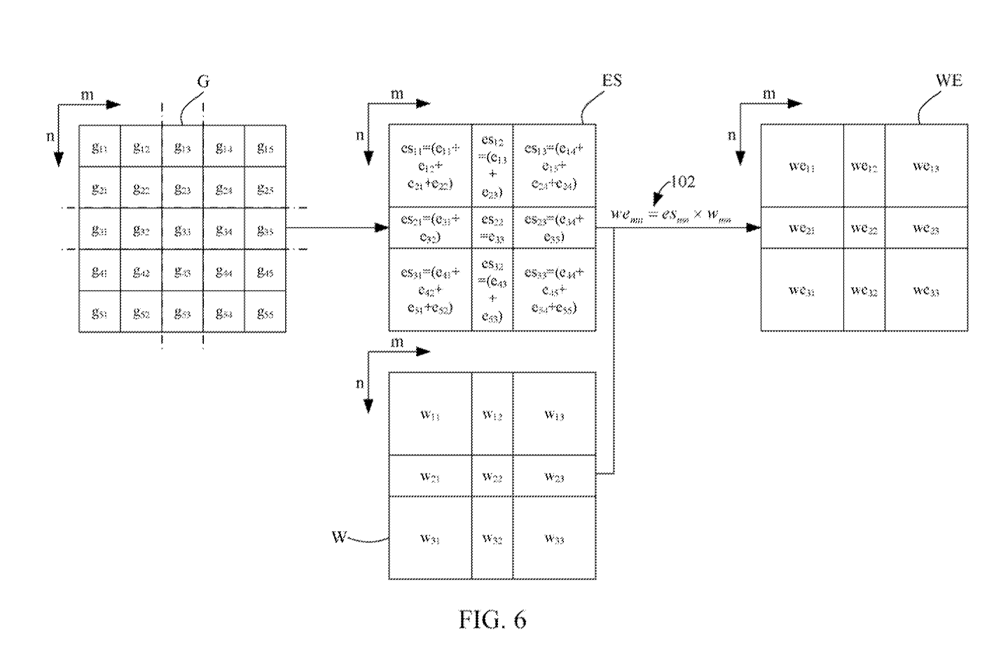

Referring to FIG. 6, the dividing unit 80 is configured for dividing the image into nine (3×3) areas (but not limited to nine), and the calculating unit 30 calculates nine contrast estimation values of the nine areas to form an area estimation value array ES (esₘₙ is an element of the area estimation value array ES at the intersection of line m and row n). The weighting unit 90 is configured for weighting the area estimation value array ES using the weighting factor array W (wₘₙ is an element of the area estimation value array W at the intersection of line m and row n) and a second equation 102 to produce a weighted area estimation value array WE (weₘₙ is an element of the area estimation value array WE at the intersection of line m and row n), thus the contrast estimation value of the image is weighted, and is related to the weighted area estimation value array WE.

Understandably, with this weighting function, a user is allowed to emphasize any area of the image on the assumption that that area is where the major subject of interest of the object scene is located. For example, the user can emphasize the central area by weighting the area estimation value array W using a weighting factor array W having a large element w₂₂ and small elements wₘₙ (m, n=1, 3). Specifically, the weighting unit 90 stores many types of weighting factor arrays W (e.g., central, top, bottom, left or right type for emphasizing the central, top, bottom, left or right area of the image) therein, and user can select any type of weighting factor array W for weighting.

In this embodiment, the weighted contrast estimation values are stored in the memory 70, and the driving unit 40 focuses the focus lens 11 and the focusing controller 50 controls the driving unit 40 based upon the weighted contrast estimation values.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An auto focus system for use in a video camera comprising:
an image sensor for capturing a plurality of consecutive images including a current image and a prior image of an object;
a pickup lens including a focus lens for focusing light from the object on the image sensor;
a calculating unit for calculating a contrast estimation value of each of the images;
a driving unit for moving the focus lens to focus the pickup lens; and
a focusing controller for judging whether a difference between the contrast estimation value of the current image and that of the prior image exceeds a predetermined threshold, if yes, activating the driving unit to focus the pickup lens, if no, deactivating the driving unit.

2. The auto focus system as claimed in claim 1, wherein the pickup lens comprises a lead screw and a step motor; the focus lens being engaged with the lead screw; the step motor being configured for driving the lead screw to rotate to force the focus lens to move stepwise along the optical axis of the focus lens.

3. The auto focus system as claimed in claim 1, wherein the focus lens is restricted to move within a focus range and in which the focus lens is adjustably positioned at one of a plurality of focus positions.

4. The auto focus system as claimed in claim 1, wherein the pickup lens comprises a zoom lens, the zoom lens and the focus lens being coaxially arranged, the zoom lens being slidable along the optical axis thereof to change the focal length of the pickup lens.

5. The auto focus system as claimed in claim 1, wherein the image sensor is selected from a group of charge coupled device image sensor and complementary metal oxide semiconductor image sensor.

6. The auto focus system as claimed in claim 1, further comprising an extracting unit for extracting a brightness component from each of the images.

7. The auto focus system as claimed in claim 1, wherein the calculating unit is configured for calculating a contrast value array of each of the images according an equation:
eₘₙ=|gₘₙ−gₘ₍ₙ₋₁₎|+|gₘₙ−gₘ₍ₙ₊₁₎|+|gₘₙ−g₍ₘ₋₁₎ₙ|+|gₘₙ−g₍ₘ₋₁₎ₙ|,
and the contrast estimation value is a function of the contrast value array, where eₘₙ is an element of the contrast value array at the intersection of line m and row n, gₘₙ is the grayscale value of a pixel of the image at the intersection of line m and row n, and m, n are positive integer.

8. The auto focus system as claimed in claim 1, further comprising:
a dividing unit for dividing the image into a plurality of areas, the calculating unit calculates a plurality of contrast estimation values of the respective areas to form an area estimation value array;
a weighting unit for weighting the area estimation value array using a weighting factor array and an equation:
weₘₙ=esₘₙ×wₘₙ
to obtain a weight area estimation value array, where weₘₙ is an element of the weighted area estimation value array at the intersection of line m and row n, esₘₙ is an element of the area estimation value array at the intersection of line m and row n, wₘₙ is an element of the area estimation value array at the intersection of line m and row n, and m and n are positive integers; the contrast estimation value being a function of the weight area estimation value array.

9. The auto focus system as claimed in claim 8, further comprising a memory for storing the calculated contrast estimation values, the driving unit and the focusing controller read the calculated contrast estimation values from the memory.

10. An auto focus method for use in a video camera having a focus lens comprising:
focusing the pickup lens and capturing a current image and a prior image;
calculating two contrast estimation values of the current image and the prior image; and
judging whether a difference between the contrast estimation value of the current image and that of the prior image exceeds a predetermined threshold, if yes, refocusing the pickup lens, if no, keeping focus status of the pickup lens unchanged and capturing a subsequent image.

11. The auto focus method as claimed in the claim 10, further comprising:
extracting a brightness component from each of the images, the contrast estimation value is calculated based upon the brightness component.

12. The auto focus method as claimed in claim 10, wherein the pickup lens comprises a focus lens, focusing the pickup lens comprising:
driving the focus lens of the pickup lens to move through a plurality of focus positions to obtain a plurality of images corresponding to the plurality of focus positions;
calculating a plurality of contrast estimation values of the plurality of images;
comparing the plurality of contrast estimation values to find the highest contrast estimation value; and
driving the focus lens to move to the focus position where the respective image with the highest contrast estimation value was obtained.

13. The auto focus system as claimed in claim 10, wherein the contrast estimation value is calculated by calculating a contrast value array based upon a brightness component of the image using an equation
eₘₙ=|gₘₙ−gₘ₍ₙ₋₁₎|+|gₘₙ−gₘ₍ₙ₊₁₎|+|gₘₙ−g₍ₘ₋₁₎ₙ|+|gₘₙ−g₍ₘ₋₁₎ₙ|,
and the contrast estimation value is a function of the contrast value array, where eₘₙ is an element of the contrast value array E at the intersection of line m and row n, gₘₙ is the grayscale value of a pixel of the image at the intersection of line m and row n, and m and n are positive integers.

14. The auto focus system as claimed in claim 13, wherein the contrast estimation value is the sum of all elements of the contrast value array.

15. The auto focus system as claimed in claim 10, wherein calculating a contrast estimation value comprising:
dividing the image into a plurality of areas, and calculating a plurality of contrast estimation values of the plurality of areas to form an area estimation value array;
weighting the area estimation value array using a weighting factor array and an equation
weₘₙ=esₘₙ×wₘₙ
to obtain a weight area estimation value array, where weₘₙ is an element of the weighted area estimation value array at the intersection of line m and row n, esₘₙ is an element of the area estimation value array at the intersection of line m and row n, wₘₙ is an element of the area estimation value array at the intersection of line m and row n, and m and n are positive integers; the contrast estimation value being a function of the weight area estimation value array.

16. The auto focus system as claimed in claim 15, wherein the contrast estimation value is the sum of all elements of the weight area estimation value array.
